(19) United States
(12) Patent Application Publication
(10) Pub. No.: US 2018/0075719 A1
(43) Pub. Date: Mar. 15, 2018

(54) Theft Detection System

(71) Applicant: Timothy McKay, Brockway, PA (US)

(72) Inventor: Timothy McKay, Brockway, PA (US)

(21) Appl. No.: 15/260,531

(22) Filed: Sep. 9, 2016

(51) Int. Cl. G08B 13/196

(52) U.S. Cl. CPC G08B 13/19647; G08B 13/19632; G08B 13/19619

(57) ABSTRACT

A theft detection system includes a vehicle that has an interior. A camera unit is coupled to the vehicle. The camera unit is positioned within the interior of the vehicle. The camera unit detects motion. The camera unit photographs of the interior when the camera unit detects motion. Thus, the camera unit captures an image of a person when the person forcibly enters the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to detection devices and more particularly pertains to a new detection device for capturing an image of a thief forcibly entering a vehicle.

### BRIEF SUMMARY OF THE INVENTION

An embodiment of the disclosure meets the needs presented above by generally comprising a vehicle that has an interior. A camera unit is coupled to the vehicle. The camera unit is positioned within the interior of the vehicle. The camera unit detects motion. The camera unit photographs of the interior when the camera unit detects motion. Thus, the camera unit captures an image of a person when the person forcibly enters the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a theft detection system according to an embodiment of the disclosure.

FIG. 2 is a back perspective view of an embodiment of the disclosure.

FIG. 3 is a perspective in-use view of an embodiment of the disclosure.

FIG. 4 is a back view of an alternative embodiment of the disclosure.

FIG. 5 is a front view of an alternative embodiment of the disclosure.

### DETAILED DESCRIPTION OF THE INVENTION

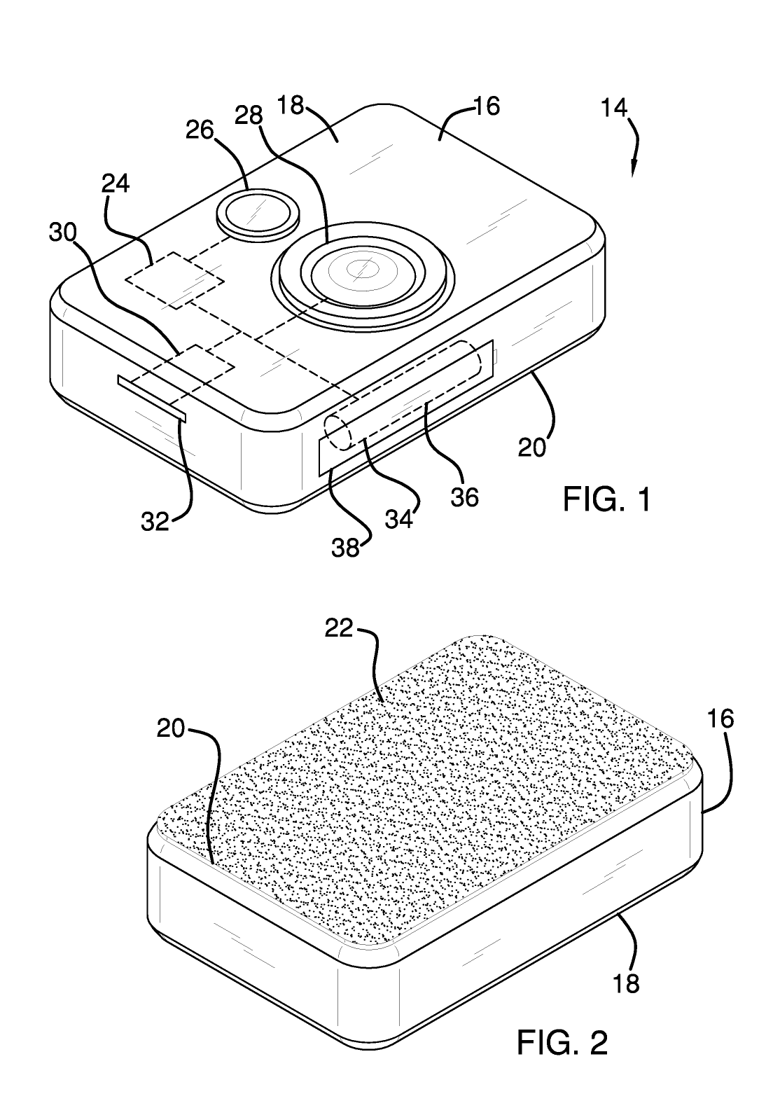

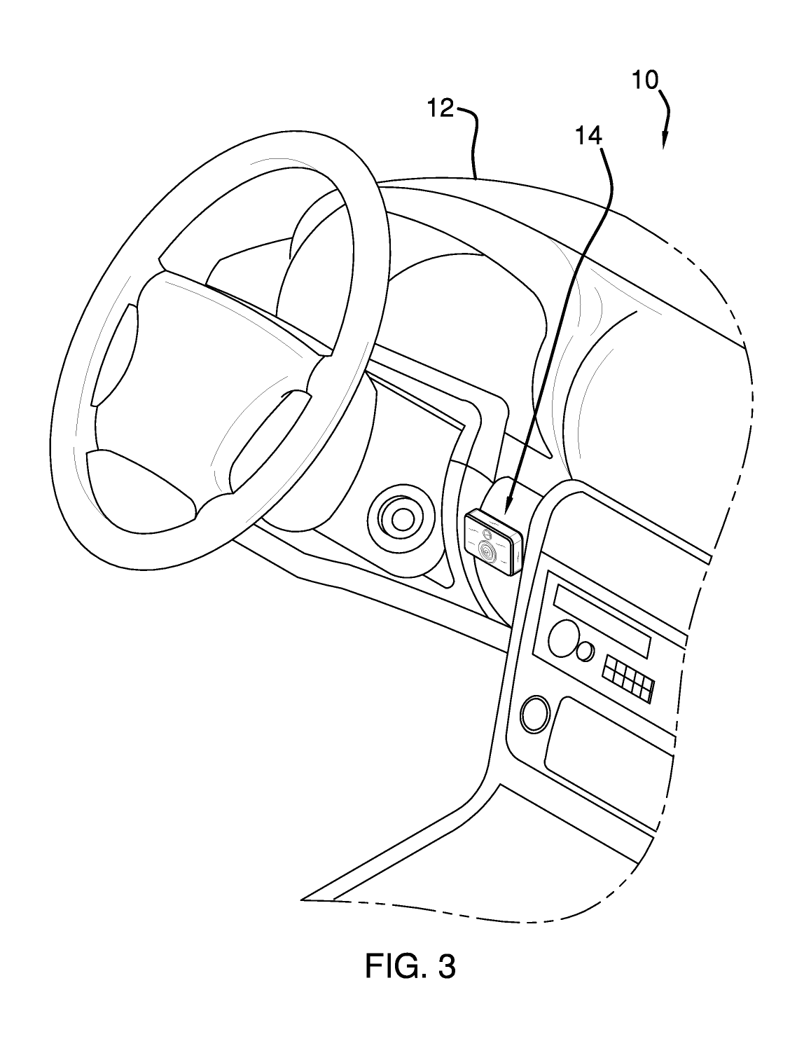

With reference now to the drawings, and in particular to FIGS. 1 through 5 thereof, a new detection device embodying the principles and concepts of an embodiment of the disclosure and generally designated by the reference numeral 10 will be described.

As best illustrated in FIGS. 1 through 5, the theft detection system 10 generally comprises a vehicle 12 has an interior. The vehicle 12 may be a passenger vehicle 12 or the like. A camera unit 14 is provided and the camera unit 14 is coupled to the vehicle 12. The camera unit 14 is positioned within the interior of the vehicle 12. The camera unit 14 detects motion. The camera unit 14 photographs of the interior when the camera unit 14 detects motion. Thus, the camera unit 14 captures an image of a person when the person forcibly enters the vehicle 12.

The camera unit 14 comprises a housing 16 that has a front wall 18 and a back wall 20. A fastener 22 is coupled to the back wall 20. The fastener 22 engages the vehicle 12 such that the housing 16 is retained on the vehicle 12. The fastener 22 may be an adhesive pad or the like. The housing 16 may be positioned on a dashboard of the vehicle 12 or other location which provides a clear view of the interior of the vehicle 12.

A processor 24 is positioned within the housing 16. The processor 24 may be an electronic processor 24 or the like. A motion detector 26 is coupled to the front wall 18. The motion detector 26 detects motion in the interior of the vehicle 12. The motion detector 26 is electrically coupled to the processor 24. Moreover, the motion detector 26 may be an electronic motion detector 26.

A camera lens 28 is provided. The camera lens 28 is coupled to the front wall 18 of the housing 16. Thus, the camera lens 28 may photograph the interior of the vehicle 12. The camera lens 28 is electrically coupled to the processor 24.

The camera lens 28 is turned on when the motion detector 26 detects motion. The camera lens 28 may be digital camera lens 28 or the like. Moreover, the camera lens 28 may be a fisheye camera lens 28 or the like. Thus, the camera lens 28 may take a panoramic image of the interior of the vehicle 12.

An electronic memory 30 is provided. The electronic memory 30 is removably coupled to the housing 16. The electronic memory 30 is electrically coupled to the processor 24 and the electronic memory 30 stores the image. The housing 16 may have a data port 32 or the like. The data port 32 may be electrically coupled to the processor 24. The electronic memory 30 may be selectively inserted into the data port 32.

A power supply 34 is provided. The power supply 34 is positioned within the housing 16. The power supply 34 is electrically coupled to the processor 24. The power supply 34 comprises at least one battery 36. A battery cover 38 is removably coupled to the housing 16. The power supply 34 is positioned beneath the battery cover 38.

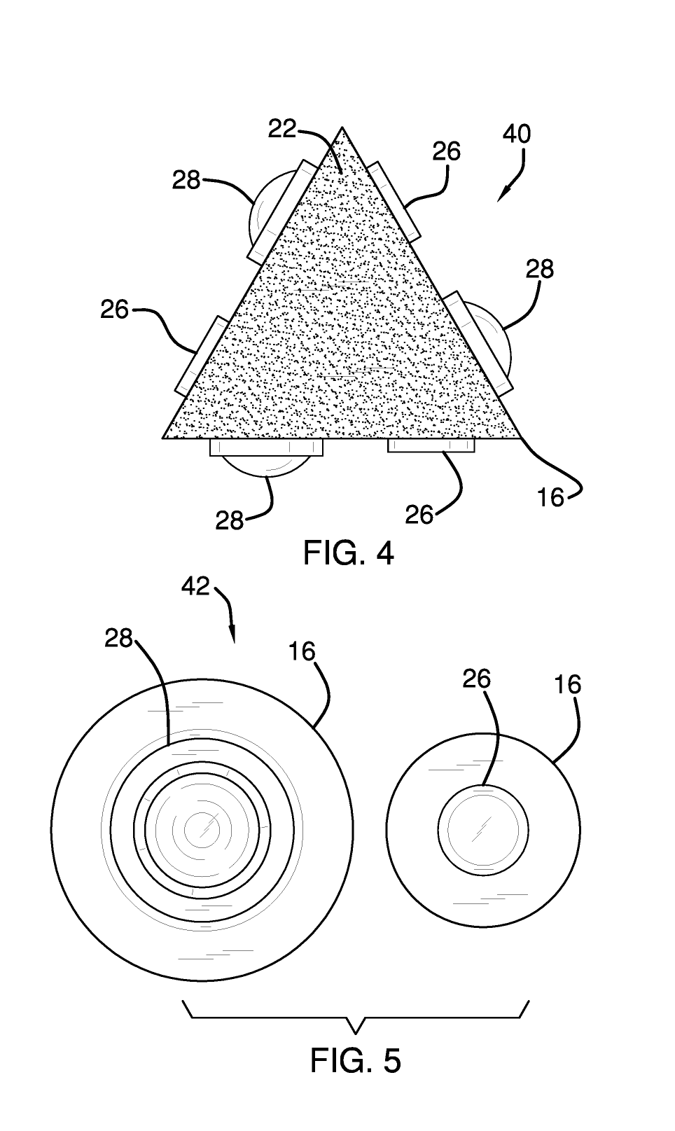

In an alternative embodiment 40 as shown in FIG. 4, the housing 16 may have a triangular shape. A plurality of motion detectors 26 may each be positioned on an associated one of the intersecting sides of the triangular shape. A plurality of camera lenses 28 may each be positioned on an associated one of the intersecting sides.

In an alternative embodiment 42 as shown in FIG. 5, a pair of housings 16 may be provided. The camera lens 28 may be coupled to an associated one of the housings 16. The motion detector 26 may be coupled to an associated one of the housings 16.

In use, the housing 16 is coupled to the vehicle 12 such that the housing 16 is positioned within the interior of the vehicle 12. The camera takes a sequence of images of the interior when the motion detector 26 detects motion. Each of the images is stored on the electronic memory 30. The images may be downloaded from the electronic memory 30 to investigate a forcible entry and theft with respect to the vehicle 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A theft detection system comprising:
a vehicle having an interior; and
a camera unit being coupled to said vehicle, said camera unit being positioned within said interior of said vehicle, said camera unit detecting motion, said camera unit photographing of said interior when said camera unit detects motion wherein said camera unit is configured to capture an image of a person when the person forcibly enters said vehicle.

2. The system according to claim 1, wherein said camera unit comprises a housing having a front wall and a back wall.

3. The system according to claim 2, further comprising a fastener being coupled to said back wall, said fastener engaging said vehicle such that said housing is retained on said vehicle.

4. The system according to claim 2, wherein a processor being positioned within said housing.

5. The system according to claim 4, further comprising a motion detector being coupled to said front wall wherein said motion detector is configured to detect motion in said interior of said vehicle, said motion detector being electrically coupled to said processor.

6. The system according to claim 5, further comprising a camera lens being coupled to said front wall of said housing wherein said camera lens is configured to photograph said interior, said camera lens being electrically coupled to said processor such that said camera lens is turned on when said motion detector detects motion.

7. The system according to claim 4, further comprising an electronic memory being removably coupled to said housing, said electronic memory being electrically coupled to said processor wherein said electronic memory is configured to store the image.

8. The system according to claim 4, further comprising a power supply being positioned within said housing, said power supply being electrically coupled to said processor, said power supply comprising at least one battery.

9. A theft detection system comprising:
a vehicle having an interior; and
a camera unit being coupled to said vehicle, said camera unit being positioned within said interior of said vehicle, said camera unit detecting motion, said camera unit photographing of said interior when said camera unit detects motion wherein said camera unit is configured to capture an image of a person when the person forcibly enters said vehicle, said camera unit comprising:
a housing having a front wall and a back wall,
a fastener being coupled to said back wall, said fastener engaging said vehicle such that said housing is retained on said vehicle,
a processor being positioned within said housing,
a motion detector being coupled to said front wall wherein said motion detector is configured to detect motion in said interior of said vehicle, said motion detector being electrically coupled to said processor,
a camera lens being coupled to said front wall of said housing wherein said camera lens is configured to photograph said interior, said camera lens being electrically coupled to said processor such that said camera lens is turned on when said motion detector detects motion,
an electronic memory being removably coupled to said housing, said electronic memory being electrically coupled to said processor wherein said electronic memory is configured to store the image, and
a power supply being positioned within said housing, said power supply being electrically coupled to said processor, said power supply comprising at least one battery.
